(19) United States
(12) Patent Application Publication
(10) Pub. No.: US 2014/0198279 A1
(43) Pub. Date: Jul. 17, 2014

(54) DISPLAY APPARATUS HAVING HAZE ELEMENT

(71) Applicant: Innolux Corporation, Miao-Li County (TW)

(72) Inventors: Jen-Chih Yang, Miao-Li County (TW); Cheng-Cheng Pan, Miao-Li County (TW); Ta-Chin Huang, Miao-Li County (TW); Chou-Yu Kang, Miao-Li County (TW); Chia-Liang Hung, Miao-Li County (TW)

(73) Assignee: Innolux Corporation, Miao-Li County (TW)

(21) Appl. No.: 14/014,453

(22) Filed: Aug. 30, 2013

(30) Foreign Application Priority Data
Jan. 11, 2013 (TW) 102101153

(51) Int. Cl. G02F 1/1335; F21V 9/14; F21V 8/00

(52) U.S. Cl. CPC G02F 1/133524; G02B 6/0011; F21V 9/14
USPC 349/62; 362/611; 362/19

(57) ABSTRACT

A display apparatus comprising a display panel, a light module and a haze element is provided. The light module comprises a light guide plate, a plurality of light guide elements and a first light emitting unit. The light guide plate comprises at least a light-entering surface and two opposite side surfaces. The light guide elements are disposed on at least one of the two side surfaces. The first light emitting unit is disposed on the light-entering surface. The haze element, disposed on the upper surface or the lower surface of the display panel, has a haze ranging between 1% and 10%. After the light emitted from the first light emitting unit enters the light guide plate, the light with the bright state being staggered with the dark state is guided from one of the side surfaces of the light-guiding plate.

This application claims the benefit of Taiwan application Serial No. 102101153, filed Jan. 11, 2013, the subject matter of which is incorporated herein by reference.

### BACKGROUND OF THE INVENTION

1. Field of the Invention

The invention relates in general to a display apparatus, and more particularly to a display apparatus having a haze element.

2. Description of the Related Art

In recent years, with the continual improvement in the manufacturing process and material, the light emitting diode (LED) technology has gained significant improvement in luminous efficiency and has been widely used in the light module of the display apparatus and other fields of application.

The light module of the display apparatus is disposed on one side of the display panel, and can be divided into two types, namely, the direct type and the side type. The side type light module comprises a light source, a light guide plate and a plurality of light guide elements. The light source exemplified by an LED light bar is disposed on one side of the light guide plate for emitting a light which enters the light guide plate via a light-entering surface of the light guide plate. Each of the light guide elements is formed by a bar-shaped scattering material, such as white ink, and is coated on a bottom surface of the light guide plate. The light guide plate guides the light to be quickly transmitted to the center from two sides through total reflection. The light guide elements break the total reflection of the light and guide the light to be emitted from the light emitting surface of the light guide plate and projected on the display panel to display an image frame.

When the light is emitted to the display panel from the light emitting surface of the light guide plate, the shape of the light on the light emitting surface is obliquely straight and with the bright state staggered with the dark state. The display panel comprises a light shielding layer (that is, a light-impermeable black matrix) formed by staggered stripes as indicated in FIG. 1. The straight stripes M of FIG. 1 are formed by the light passing through the light shielding layer. The obliquely straight stripes N are formed by the light with the bright state staggered with the dark state on the light emitting surface of the light guide plate. The straight stripes M and the obliquely straight stripes N cause optical diffraction to the light emitted from the display panel, and result in interference fringes as indicated in region A of FIG. 1 (region A only illustrates an interference fringe, and other interference fringes are not illustrated in FIG. 1). This is also referred as moiré phenomenon which deteriorates the display quality of the display apparatus.

Therefore, how to provide a light module and a display apparatus which are capable of changing the light shape and breaking interference fringes for improving the display quality of the display apparatus has become a prominent task for the industries.

### SUMMARY OF THE INVENTION

The invention is directed to a display apparatus having a haze element. The haze element is disposed on one side of the upper surface and lower surface of the display panel for changing the light shape and breaking interference fringes, so as to improve the display quality of the display apparatus.

According to an embodiment the present invention, a display apparatus, comprising a display panel, a light module and a haze element, is provided. The light module is disposed opposite to the display panel, and comprises a light guide plate, a plurality of light guide elements and a first light emitting unit. The light guide plate comprises at least a light-entering surface and two opposite side surfaces. The light guide elements are disposed on at least one of the two side surfaces. The first light emitting unit is disposed on the light-entering surface. The haze element is disposed between the display panel and the light guide plate, and has a haze ranging between 1% and 10%. After the light emitted from the first light emitting unit enters the light guide plate, the light is guided by the light-guiding plate and the light-guiding elements, and the light with the bright state being staggered with the dark state can be guided from one of the two opposite side surfaces of the light guide plate. The light guided off the light guide plate is further dispersed by the haze element.

According to another embodiment the present invention, a display apparatus, comprising a display panel, a light module and a haze element, is provided. The light module is disposed opposite to the display panel, and comprises a light guide plate, a plurality of light guide elements and a first light emitting unit. The light guide plate comprises at least a light-entering surface and two opposite side surfaces. The light guide elements are disposed on at least one side of the two side surfaces. The first light emitting unit is disposed on the light-entering surface. The haze element is disposed on one side of the display panel farther away from the light guide plate. After the light emitted from the first light emitting unit enters the light guide plate, the light is guided by the light-guiding plate and the light-guiding elements, and the light with the bright state being staggered with the dark state can be guided from one of the two opposite side surfaces of the light guide plate.

According to an alternate embodiment the present invention, a display apparatus, comprising a display panel, a light module, a polymer-dispersed liquid crystal layer, is provided. The light module is disposed opposite to the display panel, and comprises a light guide plate, a plurality of light guide elements and a first light emitting unit. The light guide plate comprises at least a light-entering surface and two opposite side surfaces. The light guide elements are disposed on at least one of the two side surfaces. The first light emitting unit is disposed on the light-entering surface. The polymer-dispersed liquid crystal layer is disposed on the side surface of the light guide plate from which the light is guided. Through voltage control, the liquid crystal direction of the polymer-dispersed liquid crystal layer is changed, such that the polymer-dispersed liquid crystal layer comprises a haze ranging between 1% and 40%.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a moiré phenomenon;

FIGS. 2A-2C are partial cross-sectional views of a display apparatus according to a first embodiment of the invention;

FIG. 3 shows a partial cross-sectional view of a display apparatus according to a second embodiment of the invention;

FIG. 4A shows a partial cross-sectional view of a display apparatus according to a third embodiment of the invention;

FIG. 4B shows a lateral cross-sectional view of a first polarizer according to a third embodiment of the invention;

FIG. 4C shows a lateral cross-sectional view of a second polarizer according to a third embodiment of the invention; and

FIGS. 5A and 5B are partial cross-sectional views of a display apparatus according to a fourth embodiment of the invention.

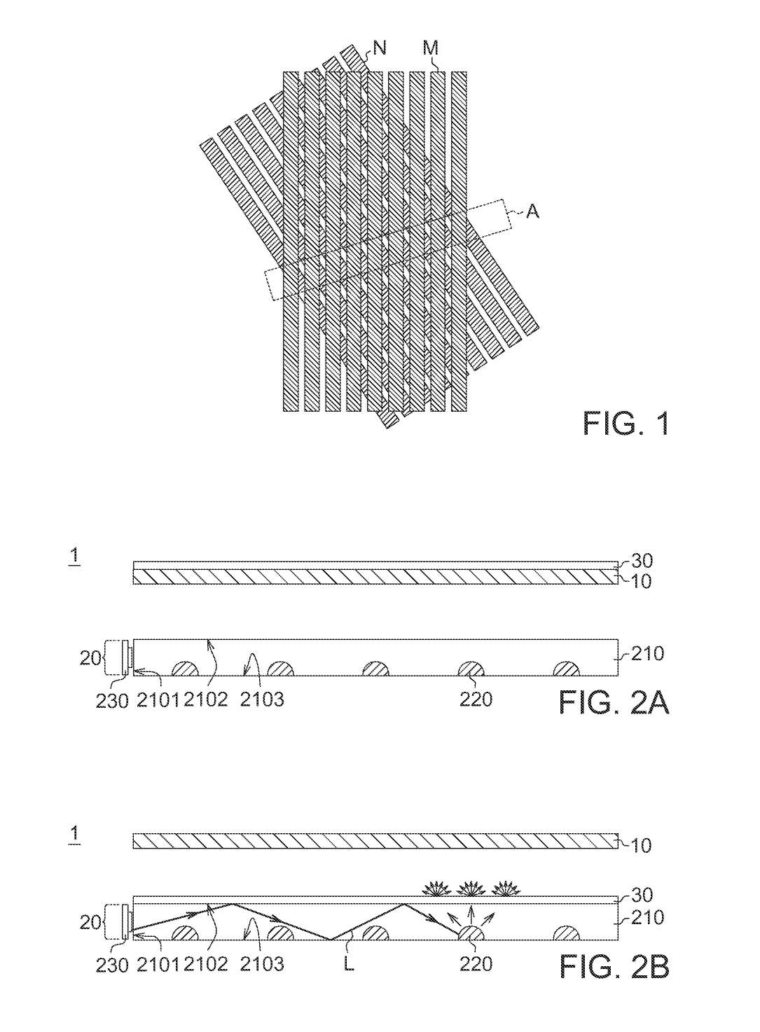

### DETAILED DESCRIPTION OF THE INVENTION

The display apparatus of an embodiment of the invention comprises a display panel, a light module and a haze element. The light module is disposed opposite to the display panel. The light module comprises a light guide plate, a plurality of light guide elements and a first light emitting unit. The light guide plate comprises a light-entering surface and two opposite side surfaces. The light guide elements are disposed on at least one side of the two side surfaces. The haze element is substantially disposed on one side of the upper surface and lower surface of the display panel. In some embodiments, the haze element has a haze ranging between 1% and 10%.

When viewing from a direction perpendicular to two opposite side surfaces, each of the light guide elements can be a straight line, an oblique line, a curve comprises at least an inflection point, or is respectively disposed according to a pixel. Details of the display apparatus are elaborated below in a first embodiment to a fourth embodiment.

### First Embodiment

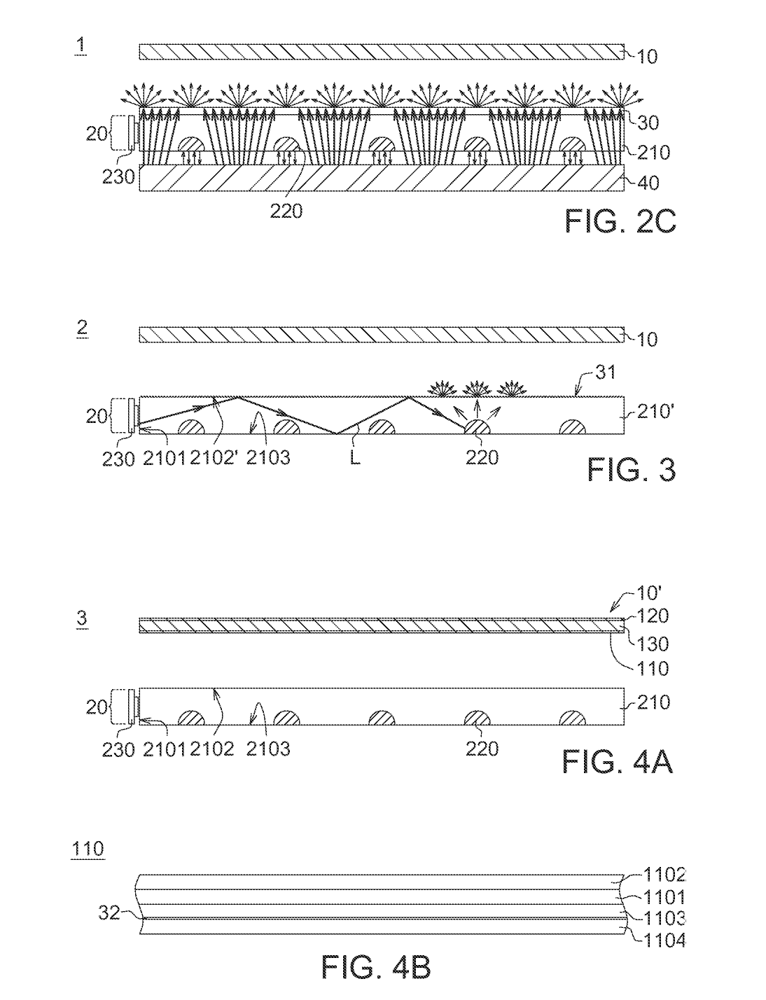

FIGS. 2A-2C are partial cross-sectional views of a display apparatus 1 according to a first embodiment of the invention. The display apparatus 1 comprises a display panel 10, a light module 20 and a haze element 30. The light module 20 is disposed opposite to the display panel 10. The light module 20 comprises a light guide plate 210, a plurality of light guide elements 220 and a first light emitting unit 230. The light guide plate 210 comprises a light-entering surface 2101 and two opposite side surfaces 2102 and 2103. The light guide elements 220 are disposed on the side surface 2103. However, the invention is not limited thereto, and the light guide elements 220 can also be disposed on the side surface 2102 or on both of the two side surfaces.

In FIG. 2A, the haze element 30 is disposed on one side of the upper surface of the display panel 10. In FIG. 2B, the haze element 30 is disposed on one side of the lower surface (between the display panel 10 and the light guide plate 210), and has a haze ranging between 1% and 10%.

In the invention, the haze of the haze element is defined as:

$$Haze = ( 1 - \frac{{T}_{diffuse}}{{T}_{total}} ) \times 100 \%$$

T_{diffuse}: the transmittance of the display apparatus having a haze element;

Tₜₒₜₐₗ: the transmittance of the display apparatus not having a haze element.

According to the structure of the test object, the haze can be divided into the internal haze or the external haze. The haze of the invention refers to the total haze of the haze element, and is not limited to the internal haze or the external haze.

For convenience of elaboration, the following description is exemplified by the structure of the embodiment of FIG. 2B. As indicated in FIG. 2B, after the light L emitted from the first light emitting unit 230 enters the light guide plate 210, the light is guided by the light-guiding plate 210 and the light guide elements 220, and a part of the light L is totally reflected by the light guide plate 210. When another part of the light L contacts the light guide elements 220, the total reflection is broken, and the light L is reflected to the side surface 2102, such that the light L with the bright state being staggered with the dark state is guided from the side surface 2102. Then, the light L guided from the side surface 2102 passes through the haze element 30, and becomes diffused and guided to the display panel 10.

Since the light L passes through the haze element 30 before entering the display panel 10, the light shape has already been changed by the haze element 30, hence avoiding generating interference fringes with the light shielding layer (not illustrated) having staggered stripes on the display panel 10 so as to effectively resolve the moiré phenomenon. In addition, the haze element 30 of the first embodiment has a haze ranging between 1% and 10%, and the light L still can be guided off with the bright state being staggered with the dark state. Therefore, the display apparatus 1 of the first embodiment of the invention effectively increases the display quality of the display apparatus. In an embodiment, the haze element 30 can be such as a diffusing film disposed on side surface 2102. The thickness of the fog film ranges between 5˜20 μm and the fog film can be formed by such as PET, PC and so on. Chemical process, mechanical process or other processes can be used to make the haze ranging between 1% and 10%.

When viewing from a direction parallel to the side surface 2102 or 2103, each of the light guide elements 220 is a recess or a protrusion. When viewing from a direction perpendicular to the side surface 2102 or 2103, each of the light guide elements 220 is a stripe, but the invention is not limited thereto. The light guide elements 220 can respectively have a reflective material disposed thereon for reflecting the light.

To put it in greater details, the light module 20 of an embodiment of the invention is a parallax barrier element of the display apparatus 10 for guiding the light L with the bright state being staggered with the dark state from the side surface 2102 of the light guide plate 210 to form a 3D image.

As indicated in FIG. 2C, the display apparatus of an embodiment of the invention comprises a backlight module 40 disposed opposite to the display panel 10. The backlight module 40 is disposed on one side of the light module 20 farther away from the display panel 10. That is, the light module 20 is disposed between the display panel 10 and the backlight module 40. By controlling the light to be emitted from the first light emitting unit 230 or the backlight module 40, the display apparatus 1 may respectively display a 3D image or a 2D image.

When the display apparatus 1 displays a 3D image, the backlight module 40 is turned off. As indicated in FIG. 2B, the light emitted from the first light emitting unit 230 is guided to the display panel 10 through the light guide plate 210 and the haze element 30. When the display apparatus 1 displays a 2D image, the backlight module 40 is turned on and the first light emitting unit 230 is turned off. As indicated in FIG. 2C, the light emitted from the backlight module 40 is guided to the display panel 10 through the light guide plate 210 and the haze element 30. It is to be noted that when the display apparatus 1 displays a 2D image, the first light emitting unit 230 can maintain the ON state for compensating the brightness of the display panel 10.

In the first embodiment, the light module 20 comprises a first light emitting unit 230. However, the invention is not limited thereto, and the light module 20 may comprise a second light emitting unit disposed on another light-entering surface opposite to the light-entering surface 2101.

### Second Embodiment

FIG. 3 shows a partial cross-sectional view of a display apparatus 2 according to a second embodiment of the invention. The second embodiment of the invention is different from the first embodiment in the disposition of the haze element. Common reference numerals are used throughout the drawings and the detailed description to indicate the same elements, and the similarities are not repeated here.

As indicated in FIG. 3, the haze element 31 of the second embodiment can directly apply surface treatment on the side surface 2102′ of the light guide plate 210′ by a mechanical process or a chemical process to form the haze element 31 having a haze ranging between 1% and 10%.

In comparison to the method of disposing a diffusing film to from a haze element, the haze element 31 of the second embodiment of the invention directly applies surface treatment on the side surface 2102′ of the light guide plate 210′, not only saving the use of material but also reducing the thickness of the display apparatus.

### Third Embodiment

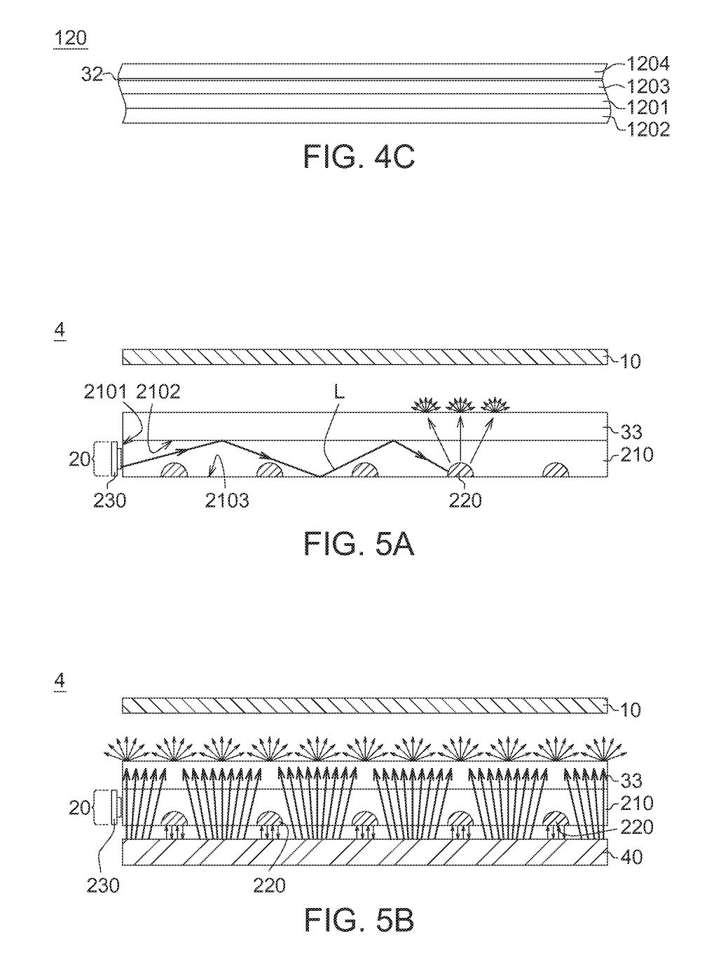

FIG. 4A shows a partial cross-sectional view of a display apparatus 3 according to a third embodiment of the invention. The third embodiment of the invention is different from the first embodiment in the disposition of the haze element. Common reference numerals are used throughout the drawings and the detailed description to indicate the same elements, and the similarities are not repeated here.

As indicated in FIG. 4A, the display panel 10′ of the display apparatus 3 of the third embodiment of the invention comprises a display unit 130, a first polarizer 110 and a second polarizer 120. The first polarizer 110 is disposed on one side of the display unit 130 closer to the light guide plate 210. The second polarizer 120 is disposed on one side of the display unit 130 farther away from the light guide plate 210. The haze element is disposed on one of the second polarizer 120 and the first polarizer 110.

In the present embodiment, the haze element can be formed by attaching a fog film on the polarizer or by applying surface treatment on an existing hard film. In FIG. 4B, the haze element is disposed on the first polarizer 110. However, the invention is not limited thereto, and the haze element of the invention can also be disposed on the second polarizer 120 (FIG. 4C).

FIG. 4B shows a lateral cross-sectional view of a first polarizer 110 according to a third embodiment of the invention. The first polarizer 110 comprises a polarizing layer 1101, a first protection layer 1102, a second protection layer 1103 and a haze element 32. The polarizing layer 1101 is used for polarizing the light entering the first polarizer 110. The first protection layer 1102 and the second protection layer 1103 are respectively disposed on the top side and bottom side of the polarizing layer 1101 for protecting the polarizing layer 1101. In an embodiment, the first protection layer 1102 is disposed between the polarizing layer 1101 and the display unit 130, the second protection layer 1103 is disposed between the polarizing layer 1101 and the light guide plate 210, and the haze element 32 can be disposed between the second protection layer 1103 and the light guide plate 210. However, the invention is not limited thereto, and the haze element 32 can also be disposed between the first protection layer 1102 and the display unit 130.

In another embodiment, the first polarizer 110 further comprises a surface protection film 1104 attached on the haze element 32. The haze element may obtain a haze ranging between 1% and 10% by applying a surface coating process on the hard film of the surface protection film 1104. The surface coating process, such as hard resin coating (HC) process, antiglare coating (AG) process, an anti-reflection coating (AR) process, antistatic coating (AS) process, and wide viewing angle improving coating (WV) process, can be applied on the surface protection film 1104 for forming the haze element thereon.

In FIG. 4B, the haze element 32 is disposed on the first polarizer 110. However, the haze element 32 can also be disposed on the second polarizer 120. When the haze element 32 is disposed on the second polarizer 120, the second polarizer 120 may comprise a structure identical or similar to that of the first polarizer 110.

FIG. 4C shows a lateral cross-sectional view of a second polarizer 120 according to a third embodiment of the invention. The second polarizer 120 comprises a polarizing layer 1201, a first protection layer 1202, a second protection layer 1203 and a haze element 32. The polarizing layer 1201 is used for polarizing the light entering the second polarizer 120. The first protection layer 1202 and the second protection layer 1203 are respectively disposed on the top side and bottom side of the polarizing layer 1201 for protecting the polarizing layer 1201. In an embodiment, the first protection layer 1202 is disposed between the polarizing layer 1201 and the display unit 130, the second protection layer 1203 is disposed on one side of the polarizing layer 1201 farther away from the display unit 130, and the haze element 32 can be disposed between the first protection layer 1202 and the display unit 130. However, the invention is not limited thereto, and the haze element 32 can also be disposed on one side of the second protection layer 1203 farther away from the display unit 130.

Similarly, the second polarizer 120 may further comprises a surface protection film 1204 attached on the haze element 32. The haze element may obtain a haze ranging between 1% and 10% by applying the surface coating process applied on the hard film of the surface protection film 1204.

### Fourth Embodiment

FIGS. 5A and 5B are partial cross-sectional views of a display apparatus according to a fourth embodiment of the invention. The invention the fourth embodiment is different from the first embodiment in the disposition of the haze element. Common reference numerals are used throughout the drawings and the detailed description to indicate the same elements, and the similarities are not repeated here.

As indicated in FIG. 5A, the display apparatus 4 comprises a polymer-dispersed liquid crystal layer (PDLC) 33 disposed on side surface 2102. Through voltage control, the liquid crystal direction of the polymer-dispersed liquid crystal layer 33 is changed, such that the polymer-dispersed liquid crystal layer 33 forms a haze element having a haze ranging between 1% and 40%.

To put it in greater details, the light module 20 of an embodiment of the invention is a parallax barrier element of the display apparatus 10. After the light L emitted from the first light emitting unit 230 enters the light guide plate 210, the light is guided by the light-guiding plate 210 and the light guide elements 220, such that the light L with the bright state being staggered with the dark state is guided from the side surface 2102. The light L guided from the side surface 2102 passes through the polymer-dispersed liquid crystal layer 33, such that the light L is diffused and guided to the display panel 10 to form a 3D image.

As indicated in FIG. 5B, the display apparatus 4 of an embodiment of the invention may also comprise a backlight module 40 disposed opposite to the display panel 10. The backlight module 40 is disposed on one side of the light module 20 farther away from the display panel 10. That is, the light module 20 is disposed between the display panel 10 and the backlight module 40. By controlling the light to be emitted from the first light emitting unit 230 or the backlight module 40, the display apparatus 4 respectively displays a 3D image or a 2D image.

When the display apparatus 4 displays a 3D image, the backlight module 40 is turned off. As indicated in FIG. 5A, the light emitted from the first light emitting unit 230 is guided to the display panel 10 through the light guide plate 210 and the polymer-dispersed liquid crystal layer 33, such that the haze of the polymer-dispersed liquid crystal layer 33 ranges between 1% and 10%.

When the display apparatus 4 displays a 2D image, the backlight module 40 is turned on and the first light emitting unit 230 is turned off. As indicated in FIG. 5B, the light emitted from the backlight module 40 is guided to the display panel 10 through the light guide plate 210 and the polymer-dispersed liquid crystal layer 33, such that a haze of the polymer-dispersed liquid crystal layer 33 ranges between 10% and 40%. In another embodiment, the haze of the polymer-dispersed liquid crystal layer 33 can be limited to be between 20% and 40%. It is to be noted that when the display apparatus 4 displays a 2D image, the first light emitting unit 230 can still maintain the ON state for compensating the brightness of the display panel 10.

When the display apparatus 4 of the fourth embodiment of the invention displays a 2D image, since the light guide elements 220 comprises a reflective material, after the light is emitted from the backlight module 40, a part of the light will be reflected by the light guide elements 220. Therefore, by increasing the haze of the polymer-dispersed liquid crystal layer 33 to be between 20% and 40%, the non-uniformity distribution of the light which occurs when the light is guided from the light guide plate 210 can be improved, and the viewable angle of the display apparatus 4 can be effectively increased. In an embodiment, when a voltage is applied to the polymer-dispersed liquid crystal layer 33, a plurality of patterned regions can be generated for increasing the light emitting angle of the light.

In the fourth embodiment, the light module 20 comprises a first light emitting unit 230. However, the invention is not limited thereto, and the light module 20 may comprise a second light emitting unit disposed on another light-entering surface opposite to the light-entering surface 2101.

According to the display panel disclosed in the above embodiments of the invention, a haze element is disposed on one side of the upper surface and lower surface of the display panel for changing the light shape and breaking the interference fringes so as to resolve the moiré phenomenon of the panel. Apart from improving the moiré phenomenon, the display panel of the invention further increases the viewable angle when displaying a 2D image, hence effectively increasing the display quality of the display apparatus.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display apparatus, comprising:
a display panel;
a light module disposed opposite to the display panel and comprising:
a light guide plate, comprising at least a light-entering surface and two opposite side surfaces;
a plurality of light guide elements disposed on at least one side of the side surfaces;
a first light emitting unit disposed on the light-entering surface, wherein after the light emitted from the first light emitting unit enters the light guide plate, the light is guided by the light-guiding plate and the light guide elements, and the light with the bright state being staggered with the dark state is guided from one of the side surfaces of the light-guiding plate;
a haze element disposed between the display panel and the light guide plate,
wherein, the haze element has a haze ranging between 1% and 10%.

2. The display apparatus according to claim 1, wherein the haze element is a diffusing film disposed on the side surface of the light guide plate from which the light is guided.

3. The display apparatus according to claim 1, wherein the haze element is formed by using a mechanical process or a chemical process to apply surface treatment on the side surface of the light guide plate from which the light is guided.

4. The display apparatus according to claim 1, wherein the display panel further comprises a display unit and a first polarizer, the first polarizer is disposed on one side of the display unit closer to the light guide plate, and the haze element is disposed on the first polarizer.

5. The display apparatus according to claim 4, wherein the first polarizer comprises:
a polarizing layer for polarizing the light entering the first polarizer;
a first protection layer and a second protection layer for protecting the polarizing layer, wherein the first protection layer is disposed between the polarizing layer and the display unit, and the second protection layer is disposed between the polarizing layer and the light guide plate;
the haze element disposed between the first protection layer and the display unit.

6. The display apparatus according to claim 4, wherein the first polarizer comprises:
a polarizing layer for polarizing the light entering the first polarizer;
a first protection layer and a second protection layer for protecting the polarizing layer, wherein the first protection layer is disposed between the polarizing layer and the display unit, and the second protection layer is disposed between the polarizing layer and the light guide plate;
the haze element disposed between the second protection layer and the light guide plate.

7. The display apparatus according to claim 1, wherein the haze element is a polymer-dispersed liquid crystal layer disposed on the side surface of the light guide plate off which the light is guided, and through voltage control, the liquid crystal direction of the polymer-dispersed liquid crystal layer is changed, such that the polymer-dispersed liquid crystal layer comprises a haze ranging between 1% and 10%.

8. The display apparatus according to claim 1, wherein the light module is a parallax barrier element of the display apparatus.

9. The display apparatus according to claim 1, wherein the display apparatus further comprises a backlight module disposed on one side of the light module farther away from the display panel, the backlight module is turned off when the display apparatus displays a 3D image, and the backlight module is turned on when the display apparatus displays a 2D image.

10. The display apparatus according to claim 1, wherein each of the light guide elements respectively has a reflective material disposed thereon.

11. The display apparatus according to claim 1, wherein the light module further comprises a second light emitting unit disposed on another light-entering surface opposite to the light-entering surface.

12. A display apparatus, comprising:
a display panel;
a light module disposed opposite to the display panel and comprising:
a light guide plate, comprising at least a light-entering surface and two opposite side surfaces;
a plurality of light guide elements disposed on at least one side of the side surfaces;
a first light emitting unit disposed on the light-entering surface, wherein after the light emitted from the first light emitting unit enters the light guide plate, the light is guided by the light-guiding plate and the light guide elements, and the light with the bright state being staggered with the dark state is guided from one of the side surfaces of the light-guiding plate;
a haze element,
wherein, the haze element is disposed on one side of the display panel farther away from the light guide plate.

13. The display apparatus according to claim 12, wherein the haze element has a haze ranging between 1% and 10%.

14. The display apparatus according to claim 12, wherein the haze element is a diffusing film.

15. The display apparatus according to claim 12, wherein the display panel comprises a display unit and a second polarizer, the second polarizer is disposed on one side of the display unit farther away from the light guide plate, and the haze element is disposed on the second polarizer.

16. The display apparatus according to claim 15, wherein the second polarizer comprises:
a polarizing layer for polarizing the light entering the second polarizer;
a first protection layer and a second protection layer for protecting the polarizing layer, wherein the first protection layer is disposed between the polarizing layer and the display unit, and the second protection layer is disposed on one side of the polarizing layer farther away from the display unit;
the haze element disposed between the first protection layer and the display unit.

17. The display apparatus according to claim 15, wherein the second polarizer comprises:
a polarizing layer for polarizing the light entering the second polarizer;
a first protection layer and a second protection layer for protecting the polarizing layer, wherein the first protection layer is disposed between the polarizing layer and the display unit, and the second protection layer is disposed on one side of the polarizing layer farther away from the display unit;
the haze element disposed on one side of the second protection layer farther away from the display unit.

18. The display apparatus according to claim 12, wherein the light module is a parallax barrier element of the display apparatus.

19. The display apparatus according to claim 12, wherein the display apparatus further comprises a backlight module disposed on one side of the light module farther away from the display panel, the backlight module is turned off when the display apparatus displays a 3D image, and the backlight module is turned on when the display apparatus displays a 2D image.

20. The display apparatus according to claim 12, wherein each of the light guide elements respectively has a reflective material disposed thereon.

21. The display apparatus according to claim 12, wherein the light module further comprises a second light emitting unit disposed on another light-entering surface opposite to the light-entering surface.

22. A display apparatus, comprising:
a display panel;
a light module disposed opposite to the display panel, comprising:
a light guide plate, comprising at least a light-entering surface and two opposite side surfaces;
a plurality of light guide elements disposed on at least one side of the side surfaces;
a first light emitting unit disposed on the light-entering surface, wherein after the light emitted from the first light emitting unit enters the light guide plate, the light is guided by the light-guiding plate and the light guide elements, and the light with the bright state being staggered with the dark state is guided from one of the side surfaces of the light-guiding plate;
a polymer-dispersed liquid crystal layer disposed on the side surface of the light guide plate from which the light is guided, and through voltage control, the liquid crystal direction of the polymer-dispersed liquid crystal layer is changed,
wherein, the polymer-dispersed liquid crystal layer comprises a haze ranging between 1% and 40%.

23. The display apparatus according to claim 22, wherein the light module is a parallax barrier element of the display apparatus.

24. The display apparatus according to claim 22, wherein the display apparatus further comprises a backlight module disposed on one side of the light module farther away from the display panel, the backlight module is turned off when the display apparatus displays a 3D image, and the backlight module is turned on when the display apparatus displays a 2D image.

25. The display apparatus according to claim 24, wherein when the display apparatus displays a 3D image, the polymer-dispersed liquid crystal layer comprises a haze ranging between 1% and 10%.

26. The display apparatus according to claim 24, wherein when the display apparatus displays a 2D image, the polymer-dispersed liquid crystal layer comprises a haze ranging between 10% and 40%.

27. The display apparatus according to claim 26, wherein when the display apparatus displays a 2D image, the polymer-dispersed liquid crystal layer has a haze ranging between 20% and 40%.

28. The display apparatus according to claim 22, wherein a voltage is applied for enabling the polymer-dispersed liquid crystal layer to generate a plurality of patterned regions for increasing the light emitting angle of the light.

29. The display apparatus according to claim 22, wherein the light module further comprises a second light emitting unit disposed on another light-entering surface opposite to the light-entering surface.

30. The display apparatus according to claim 22, wherein each of the light guide elements respectively has a reflective material disposed thereon.
